(19) United States
(12) Patent Application Publication
(10) Pub. No.: US 2008/0186320 A1
(43) Pub. Date: Aug. 7, 2008

(54) ARRANGEMENT, METHOD AND COMPUTER PROGRAM PRODUCT FOR DISPLAYING A SEQUENCE OF DIGITAL IMAGES

(75) Inventors: CARSTEN MIELENZ, Biot (FR); XIANMING DENG, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/026,923

(22) Filed: Feb. 6, 2008

(30) Foreign Application Priority Data
Feb. 6, 2007 (DE) 10 2007 005 866.9

(51) Int. Cl. G09G 5/36

(52) U.S. Cl. 345/572

(57) ABSTRACT

An arrangement for displaying a sequence of digital images is described, including a chip with a first memory for storing an increment image which can be combined with a first digital image in such a way that a second digital image arises, an off-chip second memory for storing the first digital image, a combining device, which combines the first digital image and the increment image in such a way that the second digital image arises, and a display device which displays the first digital image and the second digital image.

### CROSS-REFERENCE TO RELATED APPLICATIONS

This application claims priority from German Patent Application No. 10 2007 005 866.9, which was filed on Feb. 6, 2007, and is incorporated herein in its entirety by reference.

### TECHNICAL FIELD

Embodiments relate to an arrangement, a method and a computer program product for displaying a sequence of digital images.

### BACKGROUND

With regard to the increasing use of mobile electronic devices, inter alia, there is a need for methods and apparatuses which enable the non-jerky representation of digital video films in particular on devices having low computing power and scarce system resources, such as, for example, little fast memory.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a processing device in accordance with one exemplary embodiment;

FIG. 2 shows a plurality of digital images in accordance with one exemplary embodiment;

FIG. 3 shows a display arrangement in accordance with one exemplary embodiment; and

FIG. 4 shows a flowchart in accordance with one exemplary embodiment.

### DESCRIPTION

When representing a digital video film on a display, for example on a computer monitor, for example a cathode ray tube monitor, or on a liquid crystal display (LCD) unit of a mobile radio subscriber device, it is desirable for the data which correspond to the individual images (frames) of the video film to be able to be communicated to the display device sufficiently rapidly and also be represented sufficiently rapidly in order that the video film can be represented without being visibly jerky. Particularly in the case of small or mobile electronic devices such as, for example, in the case of mobile radio subscriber devices or embedded systems, it is simultaneously desirable for the representation of a video film to require little memory.

An arrangement for displaying a sequence of digital images is provided, including a chip with a first memory for storing an increment image which can be combined with a first digital image of the sequence of digital images in such a way that a second digital image of the sequence of digital images arises, an off-chip second memory for storing the first digital image, a combining device, which is configured to combine the first digital image and the increment image in such a way that the second digital image arises, and a display device, which is configured to display the first digital image and to display the second digital image.

A method and a computer program product in accordance with the provided arrangement for displaying a sequence of digital images are furthermore provided.

Illustratively, in accordance with one exemplary embodiment, images to be displayed may be divided into reference images (corresponding to the first digital image) and increment images. That is to say that some images, the second digital image in this case, are not stored completely, but rather only in the form of an increment image with respect to a reference image, with respect to the first digital image in this case. The reference image is stored in an off-chip memory and only the increment images are stored in an on-chip memory, which is therefore typically a memory having a shorter access time. Since it is not necessary to read all the digital images from the off-chip memory, but rather only the reference images, it is possible to use a slower memory for the off-chip memory without jerking occurring when displaying the sequence of digital images, for example if only every N-th (for instance every tenth, twentieth or hundredth) image is selected as reference image. The increment images stored on-chip can be accessed at high speed. Since the increment images only specify differences with respect to a reference image, however, they require only little memory space and the on-chip memory can be kept small and therefore cost-effective.

Reference images can be provided in the sequence of digital images for example at fixed intervals (for example every n-th image), or else dynamically. By way of example, a digital image in the sequence of digital images can be selected as a reference image when it differs greatly from the digital image last selected as a reference image, for example by more than a predetermined threshold value in more than a predetermined number of pixel values.

If only every N-th image is used as a reference image, then given sufficiently high N it is necessary only comparatively infrequently for an image to be stored in the second memory and loaded from the second memory. The required data transfer to the second memory (for example from the processor that generates the reference images) and from the second memory (for example to the combining device) is therefore low. Since the increment images only specify differences with respect to a reference image and therefore, only have a low volume of data, the required data transfer from the on-chip first memory to the combining device and also from the source of the increment images to the first memory is also comparatively low.

The configurations described in connection with the arrangement for displaying a sequence of digital images also apply analogously to the method and the computer program product for displaying a sequence of digital images.

The chip can be arranged in a mobile electronic device or in an embedded system, and the second memory can be an external memory of the mobile electronic device or embedded system. Consequently, the reference images can be stored in an external memory, for example of a mobile radio subscriber device, which is coupled to the electronic device having the chip and, for example, also the display device. By way of example, an external flash memory or an external hard disk is used for storing the first image (generally the reference images).

The increment image contains for example the difference between the pixel values of the second digital image and the first digital image. The pixel values of a pixel of a digital image should be understood to mean for example a brightness value and color values of the pixel, to put it another way luminance values and chrominance values.

The increment image contains the difference between the pixel values of the second digital image and the first digital image only for image areas in which the difference between the pixel values of the first digital image and the second digital image lies above a predetermineable threshold value.

A further reduction of the size of the increment image can thus be achieved by storing only the differences between the second digital image and the first digital image if these are sufficiently great, for example can be perceived by a person or cannot be disregarded for the desired quality of the reproduction of the sequence of digital images.

The increment image contains items of image information which specify differences between the first digital image and the second digital image. To put it another way, the increment image contains items of image information which are necessary to generate the second digital image proceeding form the first digital image. The second digital image can temporally precede or temporally succeed the first digital image, that is to say that the first digital image and the second digital image are part of a temporal sequence of digital images, for example part of a video sequence or of a 3D animation, and the first digital image in the sequence precedes of succeeds the second digital image.

The combining device is set up for example for combining the first digital image and the increment image by adding the pixel values of pixels of the increment image to the pixel values of corresponding pixels of the first digital image.

In one embodiment, the increment image is provided with at least one position vector which specifies a position of the first digital image and from which the combining device determines those pixels of the first digital image to which the pixels of the incremental image correspond.

Thus, the procedure can take place for example when the increment image contains items of image information (for example pixel values) only for the image areas of the second digital image in which the second digital image greatly differs from the first digital image. In this case, a position vector can be used to specify where an image area for which items of image information are stored is situated in the second digital image. By way of example, a position vector specifies the coordinates of the top left corner of an image area in the second digital image.

The display device displays the first digital image and the second digital image successively, for example. By way of example, the digital images of the sequence of digital images are temporally successive images of a video sequence.

By way of example, the second digital image is the digital image which temporally succeeds the first digital image in the sequence of digital images (for example directly succeeding or else with one or more temporally intervening images). As mentioned above, the second digital image can also precede the first digital image.

Accordingly, the display device can be set up for displaying the second digital image after the first digital image.

In one embodiment, the first memory is set up for storing another increment image which can be combined with the first digital image in such a way that a third digital image of the sequence of digital images arises, and the combining device is set up for combining the first digital image and the other increment image in such a way that the third digital image arises, and the display device is set up for displaying the first digital image, for displaying the second digital image and for displaying the third digital image.

The display device may be configured for example to successively display the first digital image, the second digital image and the third digital image.

In the context of this description, the terms “connected” and “coupled” are used for describing both a direct and an indirect connection and a direct or indirect coupling.

So-called double buffering, for example, can be used for representing a video film. Double buffering makes use of an image data memory subdivided into two memory areas. In accordance with one exemplary embodiment, the two memory areas are used in such a way that one memory area is filled with image data, while the image data stored in the other memory area are displayed. By way of example, firstly a first memory area is filled with image data while the image data stored in the second memory area are displayed.

Afterwards, if the first memory area has been completely filled with the image data, the image data stored in the first area are displayed and the second area is filled with new image data corresponding to the image of the video to be represented which temporally succeeds the image to which the image data in the first memory area correspond. The two memory areas should therefore be configured in such a way that they can in each case store image data corresponding to a complete image (frame) of a video. Since approximately 1.2 Mbytes per image are required for example in the case of VGA (Video Graphics Array) resolution, a considerable memory outlay can be necessary for double buffering. Since, for small electronic devices such as, for example, mobile radio subscriber devices or embedded systems, it may be the case that there is not enough memory space available internally (for example on-chip) for double buffering, it may be necessary to provide the two memory areas for double buffering in an external memory (for example off-chip memory). In this case, however, it is necessary for the external memory to be able to be accessed very rapidly. Since, recently, small electronic devices, for example mobile electronic devices, have increasingly been used to represent high-resolution video films, for example television programs or 3D graphics, it is necessary to reduce the memory required for representing the video films.

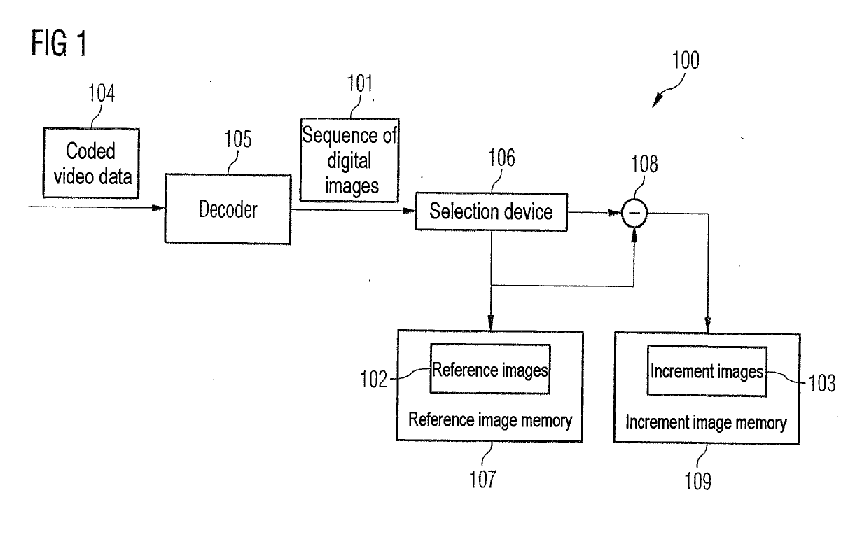

FIG. 1 shows a processing device 100 in accordance with an exemplary embodiment.

The processing device 100 may serve for determining a sequence of reference images 102 and a sequence of increment images 103 for a sequence of digital images 101. The sequence of digital images 101 is initially fed to the processing device in the form of coded video data 104. A decoder 105 decodes the coded video data 104 and thus generates the sequence of digital images 101. The coded video data 104 are for example a video film coded in accordance with an MPEG (Moving Pictures Expert Group) standard (for example MPEG-2, MPEG-4, MPEG-7) or in accordance with H.264 or in accordance with H.263. In an alternative embodiment, any other suitable, for example lossy, video coding method (also referred to as video compression method) can be used. The decoder 105 is configured as a corresponding decoder. The sequence of digital images 101 need not necessarily correspond to a video film, but rather can also be a sequence of 3D images generated by a graphics card, for example in the case of a video game.

The sequence of digital images 101 is output by the decoder 105 in a temporal order predetermined by the coded video data 104. Some of the digital images of the sequence of digital images 101 are selected as reference images by a selection device 106 and are stored as a sequence of reference images 102 in a reference image memory 107. From each digital image of the sequence of digital images 101 which was not selected as a reference image by the selection device 106, a subtractor 108 subtracts the last preceding digital image—according to the temporal order of the sequence of digital images 101—which was selected as a reference image and the resulting difference is stored as an increment image in an increment image memory 109 as an increment image of the sequence of increment images 103.

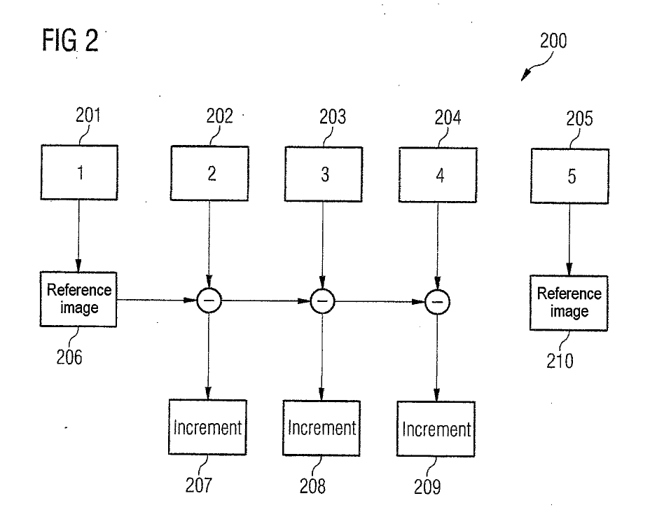

The relationship between the sequence of digital images 101, the sequence of reference images 102 and the sequence of increment images 103 will be explained in more detailed below with reference to FIG. 2.

FIG. 2 shows a plurality of digital images 200 in accordance with an exemplary embodiment.

It is assumed as an example that the sequence of digital images 101 has a first digital image 201, a second digital image 202, a third digital image 203, a fourth digital image 204 and also a fifth digital image 205. It is assumed that the selection device 106 selects the first digital image 201 as a first reference image 206 and therefore in this example as a first reference image of the sequence of reference images 102.

It is furthermore assumed that the second digital image 202 is not selected as a reference image by the selection device 106, for example since the difference between the second digital image 202 and the first digital image 201 is only very small. Therefore, the first reference image 206 is subtracted from the second digital image 202, that is to say that the luminance values and chrominance values of the pixels of the second digital image 202 and of the first reference image 206 are subtracted from one another at the respectively identical image positions, and the difference is stored as an increment image, in this example as a first increment image 207 of the sequence of increment images 103. The analogous procedure takes place in the case of the third digital image 203 and the fourth digital image 204, that is to say that the third digital image 203 and the fourth digital image 204 are not selected as reference images, the first reference image 206 is in each case subtracted from them and the resulting differences are stored as second increment image 208 and as third increment image 209, respectively, of the sequence of increment images 103 in the increment image memory 109.

In this example, the fifth digital image 205 is selected as a second reference image 210 of the sequence of reference images 102 by the selection device 106. The fifth digital image 205 is selected as a reference image for example since it differs greatly (for example differs in many pixel values) from the digital image last selected as a reference image, that is to say the first digital image 201. It may also be provided that all five digital images of the sequence of digital images 101 are selected as reference images or generally that all N-digital images are selected as reference images.

If a digital image differs from the reference image which is subtracted from it only in terms of an excerpt of the digital image, then, in one embodiment, an increment image of the same size as the digital image, which would have pixel values having the value zero at all pixels not lying in the image excerpt in which the reference image and the digital image differ, is not generated, rather only the difference between the digital image and the reference image for the image excerpt is stored. In this case, the increment image only has the size of the image excerpt. In this embodiment, the increment image is provided with a position vector specifying that location at which is situated the image excerpt of the digital image in which the digital image differs from the reference image, such that it is possible to determine that location of the reference image at which the increment image must be added to the reference image again in order to obtain the digital image. It may also be provided that the difference between the reference image and the digital image is stored only for an image excerpt where the difference lies above a specific threshold value. By way of example, the difference is stored only for an image excerpt if the image excerpt contains pixels in which the pixel value in the digital image differs from the pixel value in the reference image at least by a predetermined threshold value. Furthermore, an increment image can also include a plurality of digital images which correspond to image excerpts of the digital image which differ from the reference image. Each digital image of the plurality of digital images of the increment image can therefore be provided, as explained above, with a position vector specifying that location at which the corresponding image excerpt is situated in a digital image.

In one embodiment, the task of the selection device 106 and that of the subtractor 108 are performed by the decoder 105 itself. That is to say that the decoder 105 itself already outputs reference images and increment images and generates these for example in the course of decoding or if the type of coding is suitable, extracts them directly from the coded video data 104.

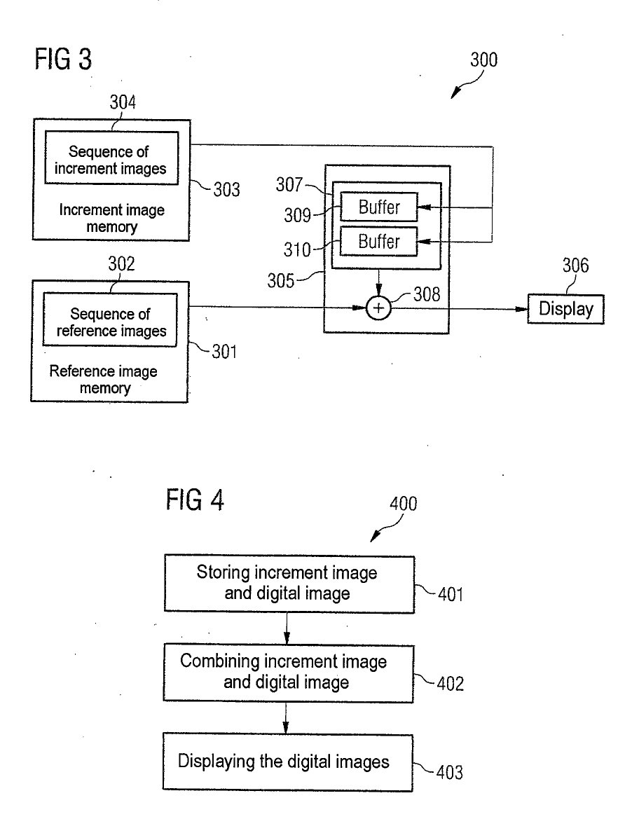

The sequence of reference images 102 and the sequence of increment images 103 are used to display the corresponding video film (or the corresponding 3D graphics). This is explained below with reference to FIG. 3.

FIG. 3 shows a display arrangement 300 in accordance with an exemplary embodiment.

The display arrangement 300 may have a reference image memory 301, which corresponds to the reference image memory 107 and in which a sequence of reference images 302 (corresponding to the sequence of reference images 102) is stored. Furthermore, the display arrangement has an increment image memory 303, which corresponds to the increment image memory 109 and in which a sequence of increment images 304 (corresponding to the sequence of increment images 103) is stored.

The display arrangement 300 has a processing device 305 and a display 306, for example a screen, for example a cathode ray tube display unit, a liquid crystal display (LCD) unit, for example a TFT (thin-film transistor) display unit, or a plasma display unit. In an alternative configuration, any other suitable display unit can be provided.

The processing device 305 is arranged for example in a (computer) chip and has a buffer memory 307, in which are stored the increment images of the sequence of increment images 304 which are fed successively to the processing device 305 from the increment image memory 303. Furthermore, the reference images of the sequence of reference images 302 are fed to the processing device 205 from the reference image memory 301.

If a reference image is fed to the processing device 305, then—if this has not yet occurred—said reference image is forwarded to the display 306 and represented. This corresponds for example to the representation of the first digital image 201 in FIG. 2. The next digital image to be represented would be the second digital image 202 in this example. In this respect, it is assumed that the first increment image 207 has been fed to the processing device 305 from the increment image memory 303 and stored in the buffer memory 307. The first increment image 207 is then added to the first reference image 206 by an adder 308 and the resulting digital image, which corresponds to the second digital image 203, is fed to the display 306 and displayed.

The subtraction carried out by the subtractor 108 and the addition carried out by the adder 308 are carried out for example simply pixel by pixel, that is to say that brightness values or color values are added and subtracted for each pixel. As explained above, an increment image can only correspond to an image excerpt of a digital image or be provided with a position indication (position vector) specifying that location at which the corresponding image excerpt is situated in the corresponding digital image. This is correspondingly taken into account by the adder 308, that is to say that the increment image is added to the reference image at the correct position. As mentioned above, an increment image can also correspond to a plurality of image excerpts with a plurality of position indications. In this case, the adder 308 adds the parts of the increment image at the locations specified by the position indications to the reference image.

In an embodiment, the adder 308 adds the increment image line by line to the reference image. By way of example, the adder has as many addition units as the reference image (or the increment image) has pixels in a column, and adds all the pixel values of the increment image and of the reference image of a line in parallel. The subtractor for generating the reference images and increment images can be configured analogously for line-by-line processing.

In this exemplary embodiment, a first memory area 309 and a second memory area 310 are provided in the buffer memory 307. The first memory area 309 and the second memory area 310 alternately store increment images of the sequence of increment images 304 which are fed to the processing device 305 from the increment image memory 303. By way of example, the first increment image 207 is stored in the first memory area 309 and, while it is added to the first reference image 206 by the adder 308, the second increment image 208 is stored in the second memory area 310. If the second digital image 202 was communicated to the display 206 and displayed, then the second increment image 208 stored in the second memory area 310 is added to the first reference image 206 and in the meantime the third increment image 209 is stored in the first memory area 309, etc.

A method in accordance with an exemplary embodiment is described in summarization below with reference to FIG. 4.

FIG. 4 shows a flow chart 400 in accordance with an exemplary embodiment.

In 401, an increment image which can be combined with a first digital image of a sequence of digital images in such a way that a second digital image of the sequence of digital images arises is stored in a chip with a first memory and the first digital image is stored in an off-chip second memory.

In 402, the first digital image and the increment image are combined in such a way that the second digital image arises.

In 403, the first digital image and the second digital image are displayed by a display device.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An arrangement for displaying a sequence of digital images, the arrangement comprising:
a chip with a first memory, which is configured to store an increment image which can be combined with a first digital image of the sequence of digital images in such a way that a second digital image of the sequence of digital images arises;
an off-chip second memory, which is configured to store the first digital image;
a combining device, which is configured to combine the first digital image and the increment image in such a way that the second digital image arises; and
a display, which is configured to display the first digital image and to display the second digital image.

2. The arrangement for displaying a sequence of digital images of claim 1, wherein the chip is arranged in one of a mobile electronic device and an embedded system.

3. The arrangement for displaying a sequence of digital images of claim 2, wherein the second memory is an external memory of the mobile electronic device or embedded system.

4. The arrangement for displaying a sequence of digital images of claim 1, wherein the increment image contains the difference between the pixel values of the second digital image and the first digital image.

5. The arrangement for displaying a sequence of digital images of claim 4, wherein the increment image contains the difference between the pixel values of the second digital image and the first digital image only for image areas in which the difference between the pixel values of the first digital image and the second digital image lies above a predetermineable threshold value.

6. The arrangement for displaying a sequence of digital images of claim 1, wherein the combining device is configured to combine the first digital image and the increment image by adding the pixel values of pixels of the increment image to the pixel values of corresponding pixels of the first digital image.

7. The arrangement for displaying a sequence of digital images of claim 6, wherein the increment image is provided with at least one position vector which specifies a position of the first digital image and from which the combining device determines those pixels of the first digital image to which the pixels of the incremental image correspond.

8. The arrangement for displaying a sequence of digital images of claim 1, wherein the display device is configured to successively display the first digital image and the second digital image.

9. The arrangement for displaying a sequence of digital images of claim 1, wherein the digital images of the sequence of digital images are temporally successive images of a video sequence.

10. The arrangement for displaying a sequence of digital images of claim 9, wherein the second digital image is the digital image which temporally succeeds the first digital image in the sequence of digital images.

11. The arrangement for displaying a sequence of digital images of claim 10, wherein the display device is configured to display the second digital image after the first digital image.

12. The arrangement for displaying a sequence of digital images of claim 1, wherein the first memory is configured to store another increment image which can be combined with the first digital image in such a way that a third digital image of the sequence of digital images arises, and the combining device is configured to combine the first digital image and the other increment image in such a way that the third digital image arises, and the display device is configured to display the first digital image, to display the second digital image and to display the third digital image.

13. The arrangement for displaying a sequence of digital images of claim 12, wherein the display device is configured to successively display the first digital image, the second digital image and the third digital image.

14. A method for displaying a sequence of digital images, the method comprising:
storing an increment image which can be combined with a first digital image of a sequence of digital images in such a way that a second digital image of the sequence of digital images arises, in a chip with a first memory;
storing the first digital image in an off-chip second memory;
combining the first digital image and the increment image in such a way that the second digital image arises; and
displaying the first digital image and the second digital image by a display device.

15. A computer program product for displaying a sequence of digital images, which, if it is executed by a processor, has the effect that a method for displaying a sequence of digital images is carried out, wherein the method comprises:
storing an increment image which can be combined with a first digital image of a sequence of digital images in such a way that a second digital image of the sequence of digital images arises, in a chip with a first memory;
storing the first digital image in an off-chip second memory;
combining the first digital image and the increment image in such a way that the second digital image arises; and
displaying the first digital image and the second digital image by a display device.

16. An electronic device having a chip and an arrangement for displaying a sequence of digital images, the electronic device comprising:
an on-chip first memory, which is configured to store an increment image which can be combined with a first digital image of the sequence of digital images in such a way that a second digital image of the sequence of digital images arises;
an off-chip second memory, which is configured to store the first digital image; a combining device, which is configured to combine the first digital image and the increment image in such a way that the second digital image arises; and
a display device, which is configured to display the first digital image and to display the second digital image.

17. An arrangement for displaying a sequence of digital images, the arrangement comprising:
a chip with a first memory, which is configured to store an increment image containing the difference between the pixel values of a second digital image of the sequence of digital images and a first digital image of the sequence of digital images;
an off-chip second memory, which is configured to store the first digital image; a combining device, which is configured to combine the first digital image and the increment image in such a way that the second digital image arises; and
a display device, which is configured to display the first digital image and to display the second digital image.
